(19) United States
(12) Patent Application Publication
(10) Pub. No.: US 2005/0058350 A1
(43) Pub. Date: Mar. 17, 2005

(54) System and method for object identification

(75) Inventors: Peter J. Dugan, Ithaca, NY (US); Zhiwei (Henry) W. Fang, Endicott, NY (US); Patrick Ouellette, Lanark (CA); Michael J. Riess, Chenango Forks, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation, Bethesda, MD (US)

(21) Appl. No.: 10/941,660

(22) Filed: Sep. 15, 2004

Related U.S. Application Data
(60) Provisional application No. 60/503,187, filed on Sep. 15, 2003.

(51) Int. Cl. G06K 9/62; G06K 9/46

(52) U.S. Cl. 382/224; 382/190

(57) ABSTRACT

Methods for object recognition and systems that implement the methods. In one embodiment, the method of this invention for processing and identifying images includes two steps. In the first step, object profile characteristics are obtained. In the second step, object profile characteristics are utilized to determine object type and orientation. A system that implements the method of this invention is also disclosed.

### CROSS REFERENCE TO RELATED APPLICATIONS

This application claims priority of U.S. Provisional Application 60/503,187 filed on Sep. 15, 2003, which is herein incorporated by reference.

### BACKGROUND OF THE INVENTION

This invention relates generally to the field of optical object recognition, and more particularly to accurate, high speed, low complexity methods for object recognition and systems that implement the methods.

In many applications, ranging from recognizing produce to recognizing moving objects, it is necessary to recognize or identify an object in an image. A number of techniques have been applied to recognizing objects in an image. Most of these techniques utilized signal processing and character recognition.

Several systems have used histograms to perform this recognition. One common histogram method develops a histogram from an image containing an object. These histograms are then compared directly to histograms of reference images. Alternatively, features of the histograms are extracted and compared to features extracted from histograms of images containing reference objects.

Other systems have used uses image characteristics to identify an object from a plurality of objects in a database. In such systems, the image is broken down into image characteristic parameters. Comparison with object data in one or more databases is utilized to identify an object in a digital image.

The above described methods are complex and are difficult to apply in a fast, real time system. Other object identification methods, based on object dimensions, exhibit several problems. Irregularities in the objects/images cause imprecise measurements, increasing false positive detection. In order to reduce false positives, more complex software is required. Furthermore, image pixel density presents a trade off between processing time and accuracy.

In some parcel container transport systems, operations are performed on various size parcel containers while the containers are being transported. By correctly identifying the type of container, the system can properly perform the desired operation. Therefore, there is a need for accurate, high speed, low complexity methods for object recognition and systems that implement the methods.

### BRIEF SUMMARY OF THE INVENTION

Accurate, high speed, low complexity methods for object recognition and systems that implement the methods are described hereinbelow.

In one embodiment, the method of this invention for processing and identifying images, where each image includes a number of one-dimensional images, includes two steps. In the first step, object features are obtained whereby pertinent features are extracted into a vector form. In the second step, an object feature vector is utilized to classify the object as belonging to an object class. In one embodiment, each object type and each orientation form a unique class and are determined through comparison to the object class.

In one embodiment the step of obtaining object features includes the following steps. First, noise is substantially removed from the one dimensional images. Then, features are extracted from the de-noised one dimensional images. Next, the extracted features are processed. (In one embodiment, the noise is removed using a median-type filter.) Finally, region of interest data are determined from the de-noised processed features.

A system that implements the method of this invention is also disclosed.

For a better understanding of the present invention, together with other and further objects thereof, reference is made to the accompanying drawings and detailed description, and its scope will be pointed out in the appended claims.

### BRIEF DESCRIPTION OF THE SEVERAL VIEWS OF THE DRAWING

FIG. 1 is a flowchart of an embodiment of the method of this invention;

FIG. 2a is a flowchart of another embodiment of the method of this invention;

FIG. 2b is a flowchart of an embodiment of a method of this invention for the extraction of the features of the object;

FIG. 2c is a flowchart of an embodiment of a method of this invention for the determination of the Region Of Interest;

FIG. 2d is a flowchart of an embodiment of a method of this invention for detection of the features of an object;

FIG. 3 is a flowchart of yet another embodiment of the method of this invention;

FIG. 4 is a block diagram representative of an embodiment of the system of this invention;

FIG. 5 is a graphical schematic representation of an embodiment of a step of the method of this invention;

FIGS. 6a, 6b, 6c, 6d, and 6e are pictorial schematic representations of an application of the method of this invention, as used in the de-noising process; and,

FIG. 7 is a graphical schematic representation of an embodiment of another step of the method of this invention.

### DETAILED DESCRIPTION OF THE INVENTION

Accurate, high speed, low complexity methods for object recognition and systems that implement the methods are described hereinbelow.

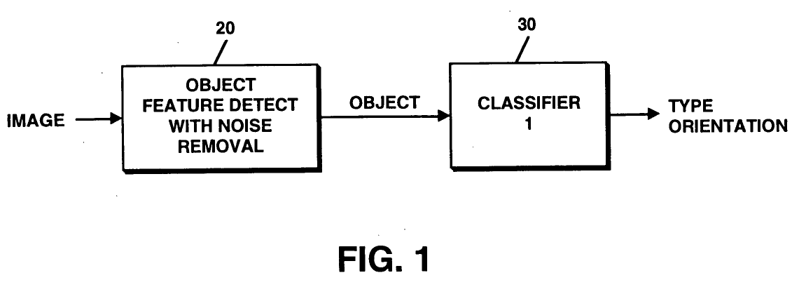

FIG. 1 is a flowchart of an embodiment of the method of this invention. Referring to FIG. 1, the embodiment 10 of the method of this invention for processing and identifying images includes two steps. In the first step (step 20, FIG. 1), object features are (post noise removal). In the second step (step 30, FIG. 1), the object features are utilized to classify the object as belonging to an object class. In a specific embodiment, the object features are extracted into a vector form. The object feature vectors, which are obtained from the de-noised features, are utilized to determine an object class, which consists of object type and orientation.

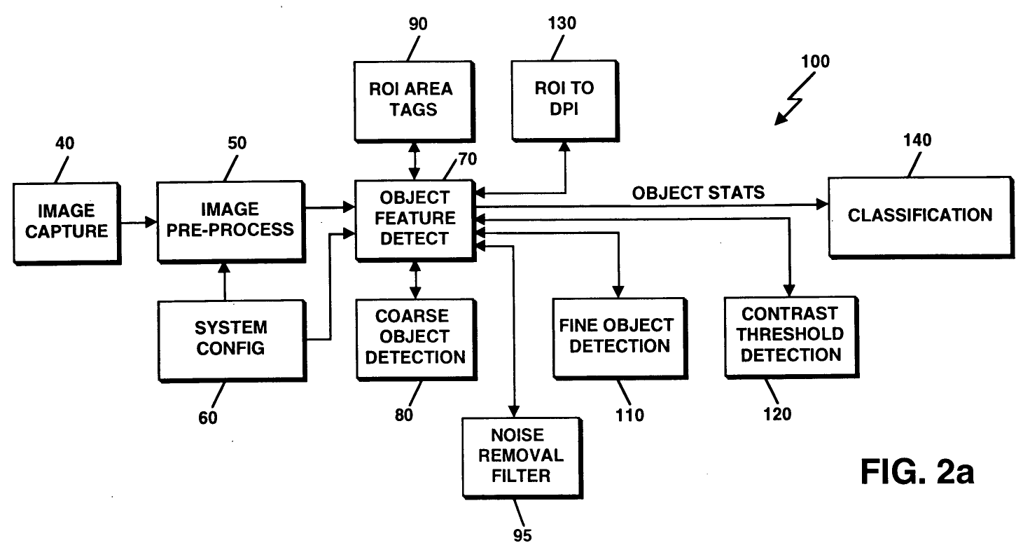

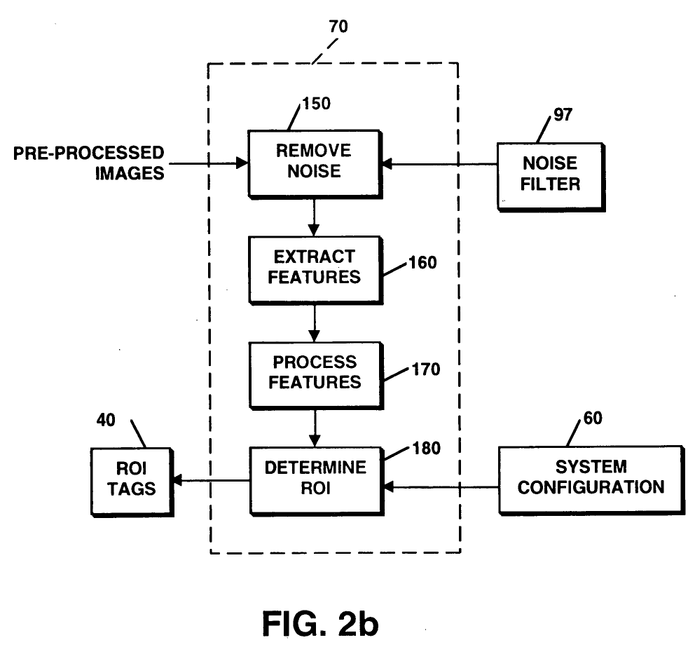

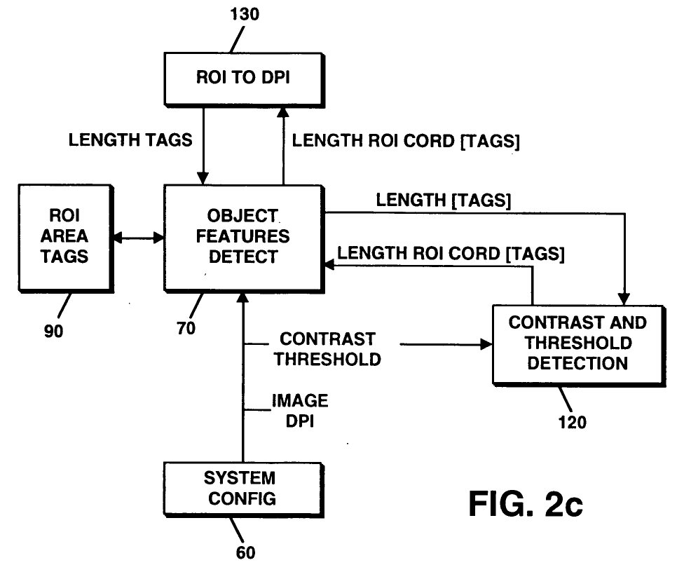

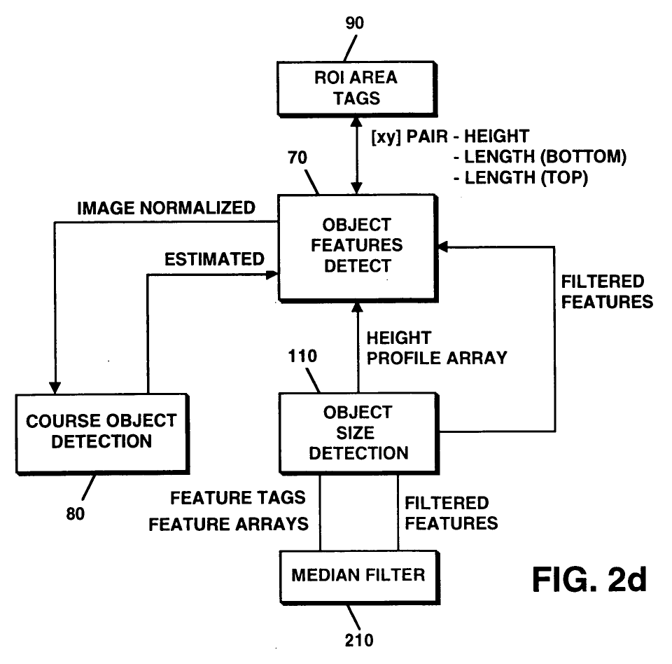

FIG. 2a is a flowchart of another embodiment 100 of the method of this invention. Referring to FIG. 2a, an image is acquired (step 40, FIG. 2a) and preprocessed to the desired image properties (resolution, cropping, noise reduction and pixel depth) (step 50, FIG. 2a). In one embodiment, the preprocessing includes utilizing image intensity and image offset data in order to obtain a normalized, cropped image. Features of an object in the image are extracted from the preprocessed image (step 70, FIG. 2a). In one embodiment, image characteristics include, but are not limited to, edge and gradient information. The detection (extraction) of the object features can, in one embodiment, include coarse detection (step 80, FIG. 2a), fine detection (step 110, FIG. 2a) and noise removal (step 95, FIG. 2a). Coarse detection provides estimated object features. (In one embodiment, coarse detection can be implemented by contrast thresholding, but this invention is not limited to this embodiment. See, for example, T. Y. Young, K. S. Fu, Handbook of Pattern Recognition and Image Processing, pp. 204-205, for contrast thresholding. Embodiments of fine detection can include, but are not limited to, edge detection, thresholding and combinations of these. See T. Y. Young, K. S. Fu. pp. 216-225) In one embodiment, system configuration data (step 60, FIG. 2a) provides input to the preprocessing of the image (step 50, FIG. 2a) and to the extraction of the object features (step 70, FIG. 2a). In a specific embodiment, contrast and threshold detection are used in obtaining the object features (step 120, FIG. 2a). Utilizing system configuration data, the object features can, in one embodiment, be converted to physical units (step 130, FIG. 2a). Finally, the object is classified utilizing the object features (step 140, FIG. 2a). (A variety of methods of classification may be employed. Examples of methods of classification, or classifier design, include, but are not limited to, the methods described in T. Y. Young, K. S. Fu. pp. 3-57, and in J. C. Bezdek, A. C. Pal, Fuzzy Models for Pattern Recognition, IEEE, N. Y., N. Y., 1992, pp. 1-25, 227-235.)

FIG. 2b is a flowchart of an embodiment of a method of this invention for the extraction of the features of the object (step 70, FIG. 2a). Referring to FIG. 2b, noise is substantially removed from the images and the image features, (step 150, FIG. 2b) utilizing a noise filter 97. Object features are extracted from the preprocessed de-noised images (step 160, FIG. 2b). The features are processed (step 170, FIG. 2b). A Region Of Interest (ROI) is then determined (step 180, FIG. 2a) and ROI parameters (Tags) obtained (step 90, FIG. 2 or 2a). (ROI determination methods can include, but are not limited to, segmentation methods, exemplary ones being those described in T. Y. Young, K. S. Fu. pp. 215-231, correlation and threshold algorithm, such as the algorithm in M. Wolf et al., “Fast Address Block Location in Handwritten and Printed Mail-piece Images”, Proc. Of the Fourth Intl. Conf. on Document Analysis and Recognition, vol. 2, pp. 753-757, Aug. 18-20, 1997, and in the algorithm disclosed in U.S. Pat. No. 5,386,482, the segmentation methods defined in P. W. Palumbo et al., “Postal Address Block Location in Real time”, Computer, Vol. 25, No. 7, pp. 34-42, July 1992, or the algorithm for generating address block candidates described in U.S. Pat. No. 6,014,450. Segmentation methods or contrast and threshold methods can be implemented to be fast but the selection of a method is determined by the desired method characteristics.)

In one embodiment, the image features are edges and gradients. Image profiles (or sections) are obtained over portions of the image. Individual groups of the image sections are integrated in order to remove noise from the profiles. The image noise is removed utilizing a one dimensional noise removal filter (for example, a “profile edge filter” for noise removal of edges; in one embodiment, the “profile edge filter” can be a median-type filter.).

FIG. 2c is a flowchart of an embodiment of a method of this invention for the determination of the Region Of Interest (ROI) (step 180, FIG. 2b). Referring to FIG. 2c, the contrast and threshold in the filtered (and noise removed) image object features are detected (step 120, FIG. 2c) and the contrast and threshold detection are utilized in extracting the features of the object (step 70, FIG. 2a). In one embodiment, object features include object size and slope, a measure of object pixel depth as compared to background pixel depth.

FIG. 2d is a flowchart of an embodiment of a method of this invention for detection of the object features including coarse and fine detection. Referring to FIG. 2d, estimated object features are obtained from the preprocessed image (step 80, FIG. 2a or 2d). A number of object feature values are obtained (step 110, FIG. 2a or 2d). The object features are filtered in order to obtain filtered object features (step 210, FIG. 2d). The filtered object features comprise the ROI area tags (step 90, FIG. 2a or 2d). In one embodiment, the filter used in filtering the number of object dimensional values is a trained FIR filter with median filter-like characteristics. (Filters with median filter like characteristics and variants of median filters, such as, but not limited to, adaptive median filters, are hereinafter referred to as median-type filters.) The filtering is tantamount to using statistics of the object profile characteristic values to remove image noise.

In the embodiment in which the image features are edges and gradients, the edge information is utilized to obtain configuration data. Dimensions of the object are obtained from the configuration data. The gradient information is utilized to obtain “slope” data.

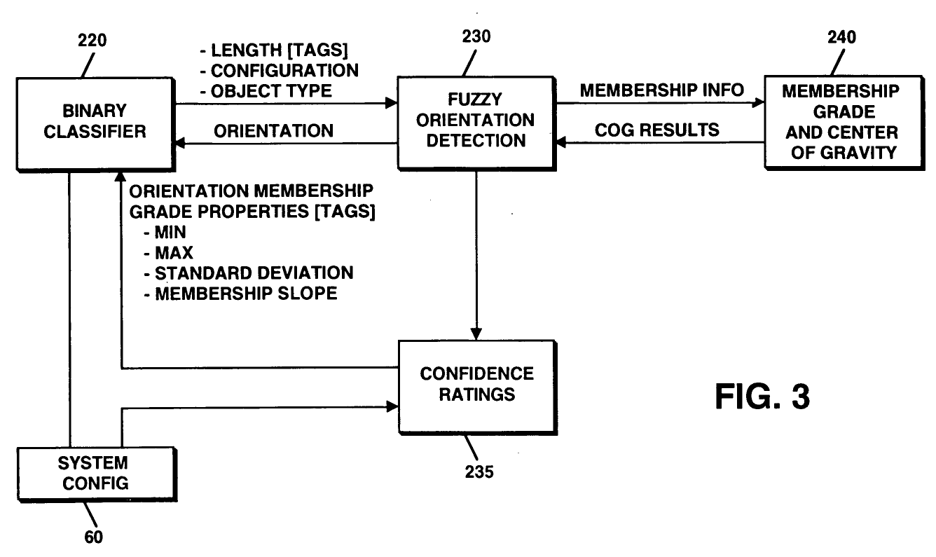

FIG. 3 is a flowchart of an embodiment 200 of a method of this invention for classifying the object. Referring to FIG. 3, the object features are provided to a binary classifier (step 220, FIG. 3). A template for each of a number of object classes, and object class data is obtained from the system configuration 60. The input object features are provided to a “fuzzy” classifier (step 230, FIG. 3). Exemplary “fuzzy” classifiers, although not a limitation of this invention, are described in J. C. Bezdek, A. C. Pal, Fuzzy Models for Pattern Recognition, IEEE, N.Y., N.Y., 1992, pp. 1-25. Type classification is obtained from the “fuzzy” classifier. System configuration data is utilized together with the type classification to generate a confidence rating (step 235, FIG. 3).). The membership grades for type information either {short, tall} and {long, not long} are obtained from the confidence rating (step 240, FIG. 3).

Referring again to FIG. 3, in one embodiment, once the object type and object profile characteristics are obtained, a more detailed classification can be performed and utilized to obtain the orientation of the object (step 250, FIG. 3). In one embodiment, the more detailed classifier is a minimum distance classifier. The minimum distance classifier can utilize, but is not limited to, Euclidean distance metrics (spherical regions) or Mahalanobis distance metrics (ellipsoidal regions). Distance classification and metrics are described in Duda, Hart, Stork, “Pattern Classification”, Wiley, 2nd edition, 2001, p. 36.

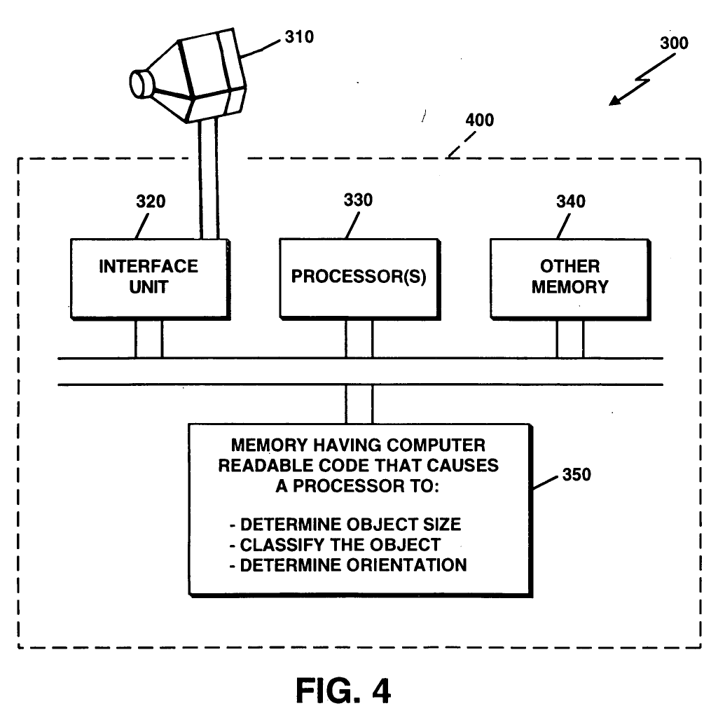

FIG. 4 depicts a block diagram representative of an embodiment of the system 300 of this invention. Acquiring means 310 (means comprising area and line acquisition devices such as CCD and CMOS imaging devices, in one embodiment) are coupled to a computer enabled system 400 (herein after called a computer system) by an interface unit 320. The interface unit 320 receives the electronic image data (not shown) from the acquiring means 310 and converts it to digital data in a form that can be processed by processor 330. Processor 330 can comprise one or many processing units. Memory 350 is a computer usable medium and has computer readable code embodied therein for determining the features of an object in the image, classifying the object and determining the orientation of the object. The computer readable code causes the processor 330 to determine the features of an object in the image, classify the object and determine the orientation of the object, implementing the methods described above and FIGS. 2a, 2b, 2c, 2d and 3. Other memory 340 is used for other system functions (for example, control of other processes, data and event logging, user interface, and other “housekeeping” functions) and could be implemented by means of any computer readable media.

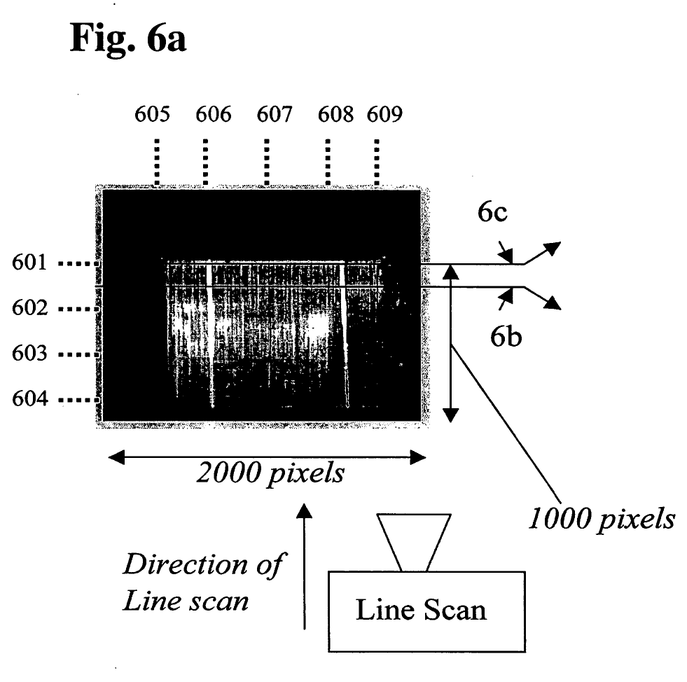

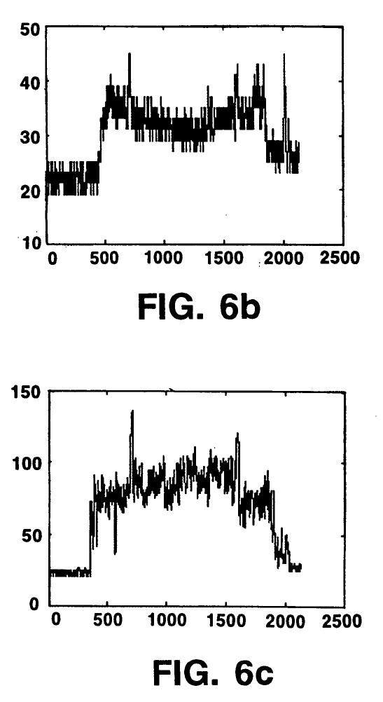

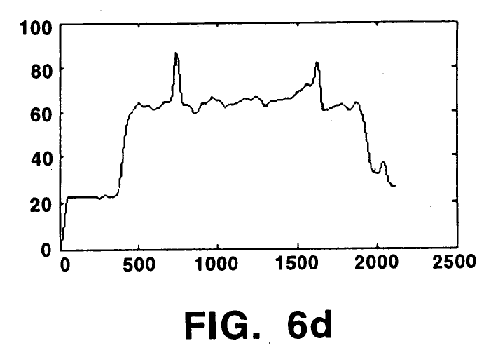

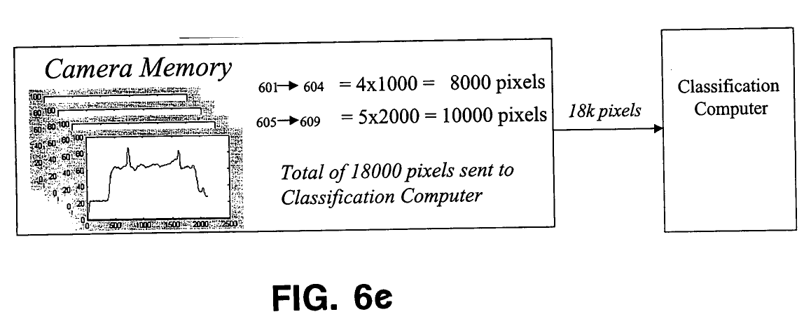

In order to better understand the present invention, the following embodiment is described. In parcel container transport systems, operations, such as removing packing bands, are performed on various size parcel-shipping containers while the containers are being transported. When containers are loaded on the transport system, the orientation of the containers may not be the required orientation. The methods and systems of this invention can be used in order to determine the type of container and the orientation of the container. In this embodiment of the method of this invention, an image including the container is acquired while the container is being transported (step 40, FIG. 2a). The image is, in one embodiment, obtained by a succession of line scan images (a number of one dimensional images) obtained as the container is being transported. (See FIGS. 6a, 6b, 6c).

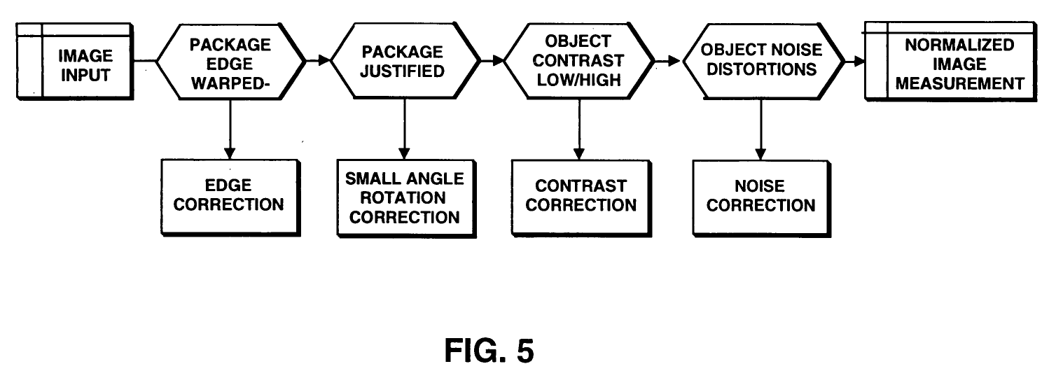

FIG. 6a shows an image of the object, a container. FIG. 6a also indicates the manner in which profiles are extracted using a line scan camera. FIGS. 6b and 6c show the output, at selected positions, of a one-dimensional line scan. The image is preprocessed to obtain the desired number of image characteristics (profiles) including, but not limited to, resolution, cropping, noise reduction and pixel depth (step 50, FIG. 2a). The preprocessing can include utilizing image intensity and image offset data in order to obtain a normalized, cropped image. (One embodiment of preprocessing is shown in FIG. 5.) Image features (edge profiles, gradients) are extracted from the camera image (step 150, FIG. 2b). Image features are obtained over sections of the line scan process. Noise is substantially removed from the image features (step 150, FIG. 2b) utilizing a one dimensional noise removal filter (such as “profile edge filter” for edges, a median-type filter in one embodiment) (97, FIG. 2a). (FIG. 6d shows the filtered image corresponding to FIGS. 6b and 6c.) The features of the image sections are integrated (in one embodiment integration includes assembling one dimensional segments into an object outline or boundary or a portion of the outline of the object) into object features (step 160, FIG. 2b). The contrast in the filtered (and noise removed) object features is detected (step 190, FIG. 2c) and the contrast and threshold detection are utilized in extracting the features of the image of the parcel container (step 70, FIG. 2a). Extracting the object features includes, in one embodiment, obtaining estimated object features from the preprocessed image (step 80, FIG. 2a or 2d). In one embodiment, estimated length data (tags) is obtained from coarse detection (step 80, FIG. 2a or 2d). A number of object image dimensional values are obtained (step 110, FIG. 2a or 2d) by means of fine detection. The object image dimensional values are filtered in order to obtain filtered object features (step 210, FIG. 2d). In one embodiment, arrays of length data are obtained and filtered during the fine detection operation and filtered length data is obtained. (FIG. 6d provides insight into the information contained in the sequence of filtered images—the physical dimensions of the object are evident in the difference in contrast as are the location of the two bands.) The filtered objects features are utilized (in one embodiment, in conjunction with contrast and threshold detection 190) to obtain the ROI area tags (step 90, FIG. 2a or 2d). In one embodiment, ROI tags include height, Length-Bottom, Length-Top. In a specific embodiment, the filter used in filtering the number of object image dimensional values is a median-type filter. The object features are input to a classifier (step 220, FIG. 3). The classifier then assigns an object to a class, whereby the class represents a unique parcel container type and container orientation.

FIGS. 6a and 6e illustrate the manner in which data is compressed into profiles by using a line scan camera. For the exemplary embodiment shown in FIG. 6a, profiles of the sample image require 10 slices to form a stable profile in FIG. 6d. Profiles that are horizontal to the line scan 601-604 can be combined and processed through the noise removal filter as the image is sampled. Vertical profiles 605-609 are stored until end of image is sampled. Vertical profiles are then integrated and processed through the noise removal filter after the image is completely passes by the end of the camera. For the sample image in FIG. 6a, 8k pixels in the horizontal (orthogonal to scan line) and 5k pixels for the vertical (parallel to scan line) reduces the total image size from 2k×1k or 2 Million down to 13k, or a lossy compression of 150:1. The process is performed in real time using a firmware solution by which profile information is then sent to a host computer where dimensional features are then extracted. It should be noted that although the above exemplary embodiment is described with specificity, this invention is not limited to the above specific embodiment.

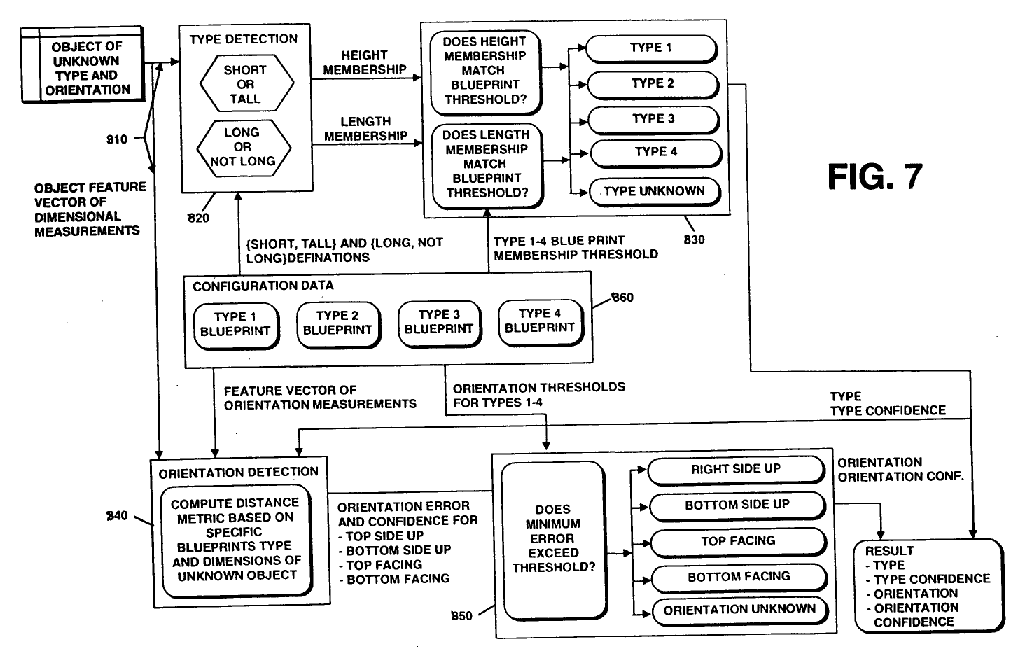

A detailed embodiment of the classification is shown in FIG. 7. FIG. 7 shows a flow-chart of one embodiment of the classifying method (steps 220, 230, FIG. 3). A template for each of a number of parcel container image types, and parcel container image type data is obtained from the system configuration 60. The input object features 810 are provided to a “fuzzy” classifier (step 230, FIG. 3). In one embodiment, the classifier operates in two stages. The first stage 820 assigns a “fuzzy” membership to the object, being {short, tall}, for height, {long, not-long} for length. This serves as a high speed coarse classification, grouping objects into type 1, type 2, type 3 or type 4. Definitions of the Fuzzy grades are retrieved from the system configuration; these serve in part as the “blueprints”. Confidence values for the membership levels are compared and a type is determined, unknown package type or “unknown” is also considered for objects that fall outside of the fuzzy tolerance value. The membership in one of the types of parcel containers and other data is obtained 830. Once the parcel container type and parcel container image features are obtained, the orientation of the parcel container can be detected 840. The next stage is to use a minimum distance classifier to refine the classification of the parcel container and attempt to determine orientation (220, FIG. 3). (See J. C. Bezdek, S. K, Pal, pp. 231-235, for example, for minimum distance classifiers.) In a specific embodiment, a Euclidean metric is used in the minimum distance classifier. System configuration data is utilized together with the type classification to generate a confidence rating for orientation 850. Orientation may be grouped accordingly as {top side up, bottom side up, top facing, bottom facing or unknown}. Orientation is assigned based on confidence levels, objects with distance metrics that are outside orientation tolerance are assigned “unknown”.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized that this invention is also capable of a wide variety of further and other embodiments all within the spirit and scope of the appended claims.

1. A method for recognizing objects, the method comprising the steps of:
acquiring a plurality of one dimensional images from an object;
obtaining object features for at least one of the plurality of one dimensional images; and,
classifying the object, utilizing the object features, as belonging to a predetermined object class;
whereby the object is recognized as belonging to the predetermined object class.

2. The method of claim 1 wherein the step of obtaining object features comprises the step of one-dimensionally processing at least one of the plurality of one dimensional images.

3. The method of claim 1 wherein the step of obtaining object features comprises the steps of:
substantially removing noise from at least one of the plurality of one dimensional images;
extracting features from at least one of the plurality of one dimensional substantially noise removed images; and
processing the extracted features.

4. The method of claim 3 further comprising the step of:
determining region of interest data from the extracted features.

5. The method of claim 1 further comprising the step of:
pre-processing the acquired plurality of one dimensional images.

6. The method of claim 3 wherein the step of processing the extracted features comprises the steps of:
processing the extracted features applying coarse detection; and,
finely detecting the coarsely detected features.

7. The method of claim 3 wherein the step of substantially removing noise comprises the step of:
filtering the at least one of the plurality of one dimensional images with a median-type filter.

8. The method of claim 3 wherein the step of processing the extracted features comprises the step of:
applying contrast and threshold detection to the extracted features.

9. The method of claim 1 wherein the step of classifying the object comprises the step of:
obtaining a confidence rating for the classification of the object features.

10. The method of claim 1 wherein the step of classifying the object comprises the step of obtaining an orientation for the object.

11. The method of claim 1 wherein the step of classifying the object comprises the step of utilizing a minimum distance classifier.

12. The method of claim 1 wherein the step of classifying the object comprises the steps of:
obtaining a coarse classification; and
refining the coarse classification.

13. A method for recognizing objects, the method comprising the steps of:
acquiring a plurality of one dimensional images from an object;
obtaining object features for at least one of the plurality of one dimensional images;
classifying the object according to object type, utilizing the object features in the classification; and,
detecting object orientation from the object type and the object profile coordinates;
whereby the object is recognized by classifying the object according to object type and detecting object orientation.

14. The method of claim 13 wherein the step of obtaining object features comprises the step of one-dimensionally processing at least one of the plurality of one dimensional images.

15. The method of claim 13 wherein the step of obtaining object features comprises the steps of:
obtaining estimated length data;
obtaining an array of height data;
obtaining a plurality of arrays of length data utilizing the estimated length data and the array of height data; and,
filtering each one of the arrays of length data.

16. The method of claim 15 wherein the step of filtering each one of the arrays comprises the step of:
filtering each one of the arrays of length data with a median-type filter.

17. The method of claim 13 wherein the object types are container types.

18. The method of claim 13 wherein the step of classifying the object comprises the steps of:
obtaining a coarse classification; and
refining the coarse classification.

19. A system for recognizing objects comprising:
means for acquiring a plurality of one dimensional images from an object;
at least one processor capable of receiving the plurality of one dimensional images; and,
at least one computer readable memory, having computer readable code embodied therein, the computer readable code capable of causing the at least one processor to:
obtain at least one object feature for at least one of the plurality of one dimensional images;
classify the object according to object type, classification being obtained from the at least one object feature; and,
detect object orientation from the object type and the at least one object feature;
whereby the object is recognized by classification according to object type and detection of object orientation.

20. The system of claim 19 wherein, in obtaining object features, the computer readable code is capable of causing the at least one processor to:
obtain estimated length data;
obtain an array of height data;
obtain a plurality of arrays of length data utilizing the estimated length data and the array of height data; and,
filter each one of the arrays of length data.

21. The system of claim 19 wherein, in classifying the object, the computer readable code is capable of causing the at least one processor to:
obtain a coarse classification; and
refine the coarse classification.

22. A computer program product comprising:
a computer usable medium having computer readable code embodied therein, the computer readable code capable of causing a computer system to:
obtain at least one object feature for at least one of the plurality of one dimensional images;
classify the object according to object type, classification being obtained from the at least one object feature; and,
detect object orientation from the object type and the at least one object feature.

23. The computer program product of claim 22 wherein, in obtaining the at least one object feature, the computer readable code is capable of causing the computer system to:
obtain estimated length data;
obtain an array of height data;
obtain a plurality of arrays of length data utilizing the estimated length data and the array of height data; and,
filter each one of the arrays of length data.

24. The computer program product of claim 22 wherein, in classifying the object, the computer readable code is capable of causing the computer system to:
obtain a coarse classification; and
refine the coarse classification.
